(19) United States
(12) Patent Application Publication
(10) Pub. No.: US 2024/0256875 A1
(43) Pub. Date: Aug. 1, 2024

(54) SYSTEM AND METHOD FOR OPTIMIZER WITH ENHANCED NEURAL ESTIMATION

(71) Applicant: Goldman Sachs & Co. LLC, New York, NY (US)

(72) Inventors: Dan Popescu, Glen Rock, NJ (US); Giovanni Faonte, Jersey City, NJ (US); Arthur Maghakian, New York, NY (US)

(21) Appl. No.: 18/160,201

(22) Filed: Jan. 26, 2023

(51) Int. Cl. G06N 3/084

(52) U.S. Cl. CPC G06N 3/084

(57) ABSTRACT

A method includes receiving a plurality of inputs including domain parameters and initial weights. The method also includes providing the plurality of inputs to an optimization model. The method also includes performing, using a first layer of the optimization model, a training and optimization process based on the plurality of inputs and based on a training objective, The method also includes performing, using a second layer of the optimization model, a differencing operation on an output of the first layer. The method also includes recording, using a third layer of the optimization model, a loss based on the training objective used by the optimization model. The method also includes calculating and storing, using a fourth layer of the optimization model, metrics regarding the training and optimization process. The method also includes outputting, using the optimization model, updated weights.

### TECHNICAL FIELD

This disclosure relates generally to machine learning systems. More specifically, this disclosure relates to a system and method for an optimizer with enhanced neural estimation.

### BACKGROUND

Existing optimization algorithms impose significant limitations on the types of objective functions and constraints users can adopt, as well as on the size of data given the high computational resource demands of existing techniques. When dealing with nonconvex/concave objectives, practitioners face either the challenging task of re-framing the problem in a quadratic or conic framework, which is oftentimes infeasible, or are severely limited by computational considerations that come with nonlinear optimization techniques (e.g., limited number of assets). Consequently, overly-simplistic assumptions can often be employed in an effort to obtain “optimal” results. However, such overly-simplistic assumptions can ignore critical information and provide inaccurate predictions.

### SUMMARY

This disclosure relates to a system and method for an optimizer with enhanced neural estimation.

In a first embodiment, a method includes receiving a plurality of inputs including domain parameters and initial weights. The method also includes providing the plurality of inputs to an optimization model. The method also includes performing, using a first layer of the optimization model, a training and optimization process based on the plurality of inputs and based on a training objective. The method also includes performing, using a second layer of the optimization model, a differencing operation on an output of the first layer. The method also includes recording, using a third layer of the optimization model, a loss based on the training objective used by the optimization model. The method also includes calculating and storing, using a fourth layer of the optimization model, metrics regarding the training and optimization process. The method also includes outputting, using the optimization model, updated weights.

In a second embodiments, an apparatus includes at least one processor supporting optimization. The at least one processor is configured to receive a plurality of inputs including domain parameters and initial weights. The at least one processor is also configured to provide the plurality of inputs to an optimization model. The at least one processor is also configured to perform, using a first layer of the optimization model, a training and optimization process based on the plurality of inputs and based on a training objective. The at least one processor is also configured to perform, using a second layer of the optimization model, a differencing operation on an output of the first layer. The at least one processor is also configured to record, using a third layer of the optimization model, a loss based on the training objective used by the optimization model. The at least one processor is also configured to calculate and store, using a fourth layer of the optimization model, metrics regarding the training and optimization process. The at least one processor is also configured to output, using the optimization model, updated weights.

In a third embodiment, a non-transitory computer readable medium contains instructions that support optimization and that when executed cause at least one processor to receive a plurality of inputs including domain parameters and initial weights. The non-transitory computer readable medium also contains instructions that when executed cause the at least one processor to provide the plurality of inputs to an optimization model. The non-transitory computer readable medium also contains instructions that when executed cause the at least one processor to perform, using a first layer of the optimization model, a training and optimization process based on the plurality of inputs and based on a training objective. The non-transitory computer readable medium also contains instructions that when executed cause the at least one processor to perform, using a second layer of the optimization model, a differencing operation on an output of the first layer. The non-transitory computer readable medium also contains instructions that when executed cause the at least one processor to record, using a third layer of the optimization model, a loss based on the training objective used by the optimization model. The non-transitory computer readable medium also contains instructions that when executed cause the at least one processor to calculate and store, using a fourth layer of the optimization model, metrics regarding the training and optimization process. The non-transitory computer readable medium also contains instructions that when executed cause the at least one processor to output, using the optimization model, updated weights.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example system supporting optimization with enhanced neural estimation in accordance with this disclosure;

FIG. 2 illustrates an example device supporting optimization with enhanced neural estimation in accordance with this disclosure;

FIG. 3 illustrates an example functional architecture for an optimization model in accordance with this disclosure;

FIG. 4 illustrates an example optimization model process in accordance with this disclosure;

FIG. 5 illustrates an example portfolio optimization model process in accordance with this disclosure; and

FIGS. 6A and 6B illustrate an example method for performing a training and optimization process using an optimization model in accordance with this disclosure.

### DETAILED DESCRIPTION

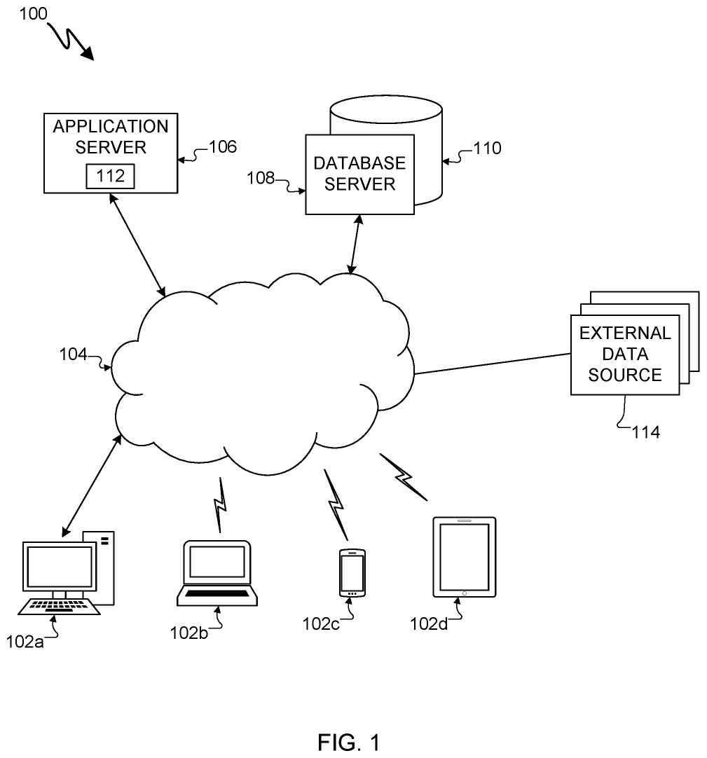

FIGS. 1 through 6B, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, existing optimization algorithms impose significant limitations on the types of objective functions and constraints users can adopt, as well as on the size of data given the high computational resource demands of existing techniques. When dealing with nonconvex/concave objectives, practitioners face either the challenging task of re-framing the problem in a quadratic or conic framework, which is oftentimes infeasible, or are severely limited by computational considerations that come with nonlinear optimization techniques (e.g., limited number of assets). Consequently, overly-simplistic assumptions can often be employed in an effort to obtain “optimal” results. However, such overly-simplistic assumptions can ignore critical information and provide inaccurate predictions.

The various embodiments of this disclosure provide an optimizer that provides enhanced neural estimation. The optimizer is an optimization model built using neural networks and is used, for example, to calculate gradients and do direct search in a highly efficient manner that takes into consideration various complex parameters, inputs, and constraints. In various embodiments, the optimization model performs multi-period optimization on complex data provided by one or more feeder models and can optimize the weights used by those feeder models to provide for more accurate predictions and data correlations. The optimization model can take as inputs from the feeder models domain parameters, that is, the data used by and predicted using the feeder models, initial weights from the feeder models, and optional final weights from the feeder models, which can be modified and primed for optimization by applying predetermined objectives and constraints to the inputs. The optimization model then performs various optimizations processes as described in embodiment of this disclosure to output updated model weights to be used to better predict results germane to the original feeder models.

As one non-limiting example, in some embodiments, the optimization model can be used as a portfolio optimization network for equity trading of quantitative investment strategies. The portfolio optimization network can be used for generating trading suggestions for portfolio managers that minimize transaction costs while maximizing the returns for a given level of risk. Modern portfolio theory aims to maximize portfolio returns at a given level of risk, and portfolio optimization remains the cornerstone of asset management. The original optimization problem addressed in modern portfolio theory can be solved using modern quadratic programming approaches. However, such approaches impose significant limitations on the types of objective functions and constraints portfolio managers can adopt in portfolio construction, as well as on the size of portfolios given the techniques' high computational resource demands. Therefore, when dealing with nonconvex/concave objectives, practitioners face either the challenging task of re-framing the problem in a quadratic or conic framework, which is oftentimes infeasible, or are severely limited by computational considerations that come with nonlinear optimization techniques, such as a limited number of assets. Consequently, overly-simplistic assumptions can often be employed in an effort to obtain “optimal” portfolios. One of such commonly used assumptions is that transaction costs of constructing or rebalancing portfolios are negligible.

In practice, transaction costs can be very material, in particular for large assets under management (AUM) portfolios and can change non-linearly depending on the traded positions, asset volatilities, average daily traded volumes, etc. To mitigate the effect of high transaction costs, portfolio managers often rebalance large positions in multiple days to reduce the market impact transaction costs. To properly capture such costs, multi-day rebalancing should also take into consideration longer term impact of trading and changes in projected returns (alpha decay) and risk with time. This further leads to both increased dimensions of the problem, as well as complicated, non-convex objective functions. Therefore, realistic models should use multi-period optimization engines, which are efficient in high-dimensional optimization problems under complex non-linear objective functions and constraints and are able to generate a sequence of trades to carry over multiple periods.

In practice, multi-period portfolio optimization is difficult to implement for several reasons. First, multi-period models are computationally intensive, especially if the universe of assets considered is large. Second, the most common existing multi-period models do not handle real-world constraints. Finally, projection of returns, transaction costs and risk for multiple days can be challenging on its own. Largely because of these reasons, attempts to construct robust multi-period optimizers have largely been unsuccessful in the past. Moreover, even now, the vast majority of portfolio managers across the industry continue to rely on one-period optimizers.

However, the optimization model of this disclosure can use fast and precise calculations of gradients in neural networks combined with enhancements in computing capacity to provide a direct search neural optimizer that addresses the challenges highlighted above. In various embodiments, the optimization model is built using neural networks but does not provide direct inferences. Rather, the optimization model uses a neural network-based approach to calculate gradients, perform direct searching, and update neural network parameters in a highly efficient manner.

In various embodiments, the optimization model, when used for portfolio management, can use five categories of inputs: projections of future returns, equity volumes and risk in the form of a variance-covariance matrix, current positions/holdings, portfolio/account constraints, benchmark, and volume estimation. All these inputs can be defined for each period (such as a day). Most of the time, inputs to the optimization model will be generated by quantitative investment strategy models (feeder models) already approved and used by portfolio managers. The output of the optimization model can be the weights of the portfolio for each period (such as each day).

FIG. 1 illustrates an example system 100 supporting optimization with enhanced neural estimation in accordance with this disclosure. As shown in FIG. 1, the system 100 includes multiple electronic devices 102a-102d such as electronic computing devices, at least one network 104, at least one application server 106, and at least one database server 108 associated with at least one database 110. Note, however, that other combinations and arrangements of components may also be used here.

In this example, each electronic device 102a-102d is coupled to or communicates over the network(s) 104. Communications between each electronic device 102a-102d and at least one network 104 may occur in any suitable manner, such as via a wired or wireless connection. Each electronic device 102a-102d represents any suitable device or system used by at least one user to provide information to the application server 106 or database server 108 or to receive information from the application server 106 or database server 108. Any suitable number(s) and type(s) of electronic devices 102a-102d may be used in the system 100. In this particular example, the electronic device 102a represents a desktop computer, the electronic device 102b represents a laptop computer, the electronic device 102c represents a smartphone, and the electronic device 102d represents a tablet computer. However, any other or additional types of electronic devices may be used in the system 100. Each electronic device 102a-102d includes any suitable structure configured to transmit and/or receive information.

The at least one network 104 facilitates communication between various components of the system 100. For example, the network(s) 104 may communicate Internet Protocol (IP) packets, frame relay frames, Asynchronous Transfer Mode (ATM) cells, or other suitable information between network addresses. The network(s) 104 may include one or more local area networks (LANs), metropolitan area networks (MANs), wide area networks (WANs), all or a portion of a global network such as the Internet, or any other communication system or systems at one or more locations. The network(s) 104 may also operate according to any appropriate communication protocol or protocols.

The application server 106 is coupled to the at least one network 104 and is coupled to or otherwise communicates with the database server 108. The application server 106 can support various functions related to optimization with enhanced neural estimation embodied by at least the application server 106 and the database server 108. For example, the application server 106 may execute one or more applications 112, which can include the optimizer of the various embodiments of this disclosure and which can be used to receive requests for using the unique optimizer of the various embodiments of this disclosure to calculate gradients, optimize weights, and perform direct searching in a highly efficient manner. Data to be used by the unique optimizer can be received by the one or more applications 112 from remote devices, such as one or more of the electronic devices 102a-102d. In some embodiments, data to be used by the unique optimizer can be stored in and retrieved from one or more databases 110 of the database server 108. The application server 106 can interact with the database server 108 in order to store information in and retrieve information from the database 110 as needed or desired. Additional details regarding example functionalities of the application server 106 are provided below. The one or more applications 112 may also present one or more graphical user interfaces to users of the electronic devices 102a-102d, such as one or more graphical user interfaces that allow a user to retrieve and view data created and/or predicted from initial data and using machine learning models that are optimized using the unique optimizer of the various embodiments of this disclosure, and display associated results.

The database server 108 operates to store and facilitate retrieval of various information used, generated, or collected by the application server 106 and the electronic devices 102a-102d in the database 110. For example, the database server 108 may store various types of data to be used by the unique optimizer and other components of this disclosure, such as information used in analyzing market data, statistics, signal processing, pattern recognition, econometrics, mathematical finance, weather forecasting, earthquake prediction, electroencephalography, control engineering, astronomy, communications engineering, and largely in any domain of applied science and engineering which involves temporal measurements, such as information including annual sales data, monthly subscriber numbers for various services, stock prices, Internet of Things (IoT) device data and/or statuses, such as data related to various measured metrics like temperature, rainfall, heartbeats per minute, etc., stored in the database 110. Note, however, that the database server 108 may be used within the application server 106 to store information in other embodiments, in which case the application server 106 may store the information itself.

Some embodiments of the system 100 allow for information to be harvested or otherwise obtained from one or more external data sources 114 and pulled into the system 100, such as for storage in the database 110 and use by the application server 106. In some embodiments, the one or more external data sources 114 can include feeder models as described in this disclosure. Each external data source 114 represents any suitable source of information that is useful for performing one or more analyses or other functions of the system 100. At least some of this information may be stored in the database 110 and used by the application server 106 to perform one or more analyses or other functions using the data stored in the database 110. Depending on the circumstances, the one or more external data sources 114 may be coupled directly to the network(s) 104 or coupled indirectly to the network(s) 104 via one or more other networks.

In some embodiments, the functionalities of the application server 106, the database server 108, and the database 110 may be provided in a cloud computing environment, such as by using a proprietary cloud platform or by using a hosted environment such as the AMAZON WEB SERVICES (AWS) platform, the GOOGLE CLOUD platform, or MICROSOFT AZURE. In these types of embodiments, the described functionalities of the application server 106, the database server 108, and the database 110 may be implemented using a native cloud architecture, such as one supporting a web-based interface or other suitable interface. Among other things, this type of approach drives scalability and cost efficiencies while ensuring increased or maximum uptime. This type of approach can allow the electronic devices 102a-102d of one or multiple organizations (such as one or more companies) to access and use the functionalities described in this patent document. However, different organizations may have access to different data or other differing resources or functionalities in the system 100.

In some cases, this architecture uses an architecture stack that supports the use of internal tools or datasets (meaning tools or datasets of the organization accessing and using the described functionalities) and third-party tools or datasets (meaning tools or datasets provided by one or more parties who are not using the described functionalities). Datasets used in the system 100 can have well-defined models and controls in order to enable effective importation and use of the datasets, and the architecture may gather structured and unstructured data from one or more internal or third-party systems, thereby standardizing and joining the data source(s) with the cloud-native data store. Using a modern cloud-based and industry-standard technology stack can enable the smooth deployment and improved scalability of the described infrastructure. This can make the described infrastructure more resilient, achieve improved performance, and decrease the time between new feature releases while accelerating research and development efforts.

Among other possible use cases, a native cloud-based architecture or other architecture designed to use the optimizer and associated methods in accordance with this disclosure can be used to leverage data such as market data with advanced data analytics in order to make investing processes more reliable and reduce uncertainty. In these types of architectures, the described functionalities can be used to obtain various technical benefits or advantages depending on the implementation. For example, these approaches can be used to drive intelligence in investing processes or other processes by providing users and teams with information that can only be accessed through the application of data science and advanced analytics. Based on the described functionalities, the approaches in this disclosure can meaningfully increase sophistication for functions such as selecting markets, analyzing transactions, managing risk and returns, etc.

The value or benefits of data science and advanced analytics driven by the described approaches can be highly useful or desirable. For example, deal sourcing can be driven by deeply understanding the drivers of market performance in order to identify high-quality assets early in their lifecycles to increase or maximize investment returns. This can also position institutional or corporate investors to initiate outbound sourcing efforts in order to drive proactive partnerships with operating partners. Moreover, with respect to transaction analysis during diligence and execution phases of transactions, this can help optimize deal tactics by providing precision and clarity to underlying market fundamentals.

Although FIG. 1 illustrates one example of a system 100 supporting optimization with enhanced neural estimation, various changes may be made to FIG. 1. For example, the system 100 may include any number of electronic devices 102a-102d, networks 104, application servers 106, database servers 108, databases 110, applications 112, and external data sources 114. Also, these components may be located in any suitable locations and might be distributed over a large area. In addition, while FIG. 1 illustrates one example operational environment in which optimization with enhanced neural estimation may be used, this functionality may be used in any other suitable system.

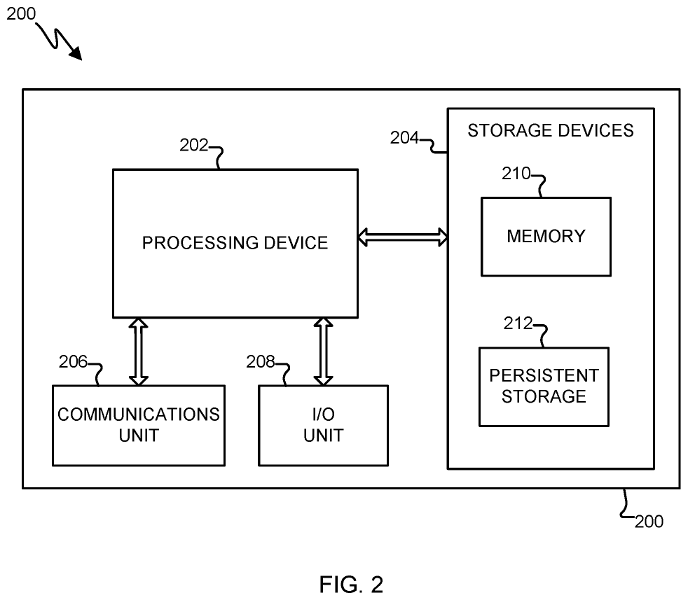

FIG. 2 illustrates an example device 200 supporting optimization with enhanced neural estimation in accordance with this disclosure. One or more instances of the device 200 may, for example, be used to at least partially implement the functionality of the application server 106 of FIG. 1. However, the functionality of the application server 106 may be implemented in any other suitable manner. In some embodiments, the device 200 shown in FIG. 2 may form at least part of an electronic device 102a-102d, application server 106, or database server 108 in FIG. 1. However, each of these components may be implemented in any other suitable manner.

As shown in FIG. 2, the device 200 denotes a computing device or system that includes at least one processing device 202, at least one storage device 204, at least one communications unit 206, and at least one input/output (I/O) unit 208. The processing device 202 may execute instructions that can be loaded into a memory 210. The processing device 202 includes any suitable number(s) and type(s) of processors or other processing devices in any suitable arrangement. Example types of processing devices 202 include one or more microprocessors, microcontrollers, digital signal processors (DSPs), application specific integrated circuits (ASICs), field programmable gate arrays (FPGAs), or discrete circuitry.

The memory 210 and a persistent storage 212 are examples of storage devices 204, which represent any structure(s) capable of storing and facilitating retrieval of information (such as data, program code, and/or other suitable information on a temporary or permanent basis). The memory 210 may represent a random access memory or any other suitable volatile or non-volatile storage device(s). The persistent storage 212 may contain one or more components or devices supporting longer-term storage of data, such as a read only memory, hard drive, Flash memory, or optical disc. The device 200 can also access data stored in external memory storage locations the device 200 is in communication with, such as one or more online storage servers.

The communications unit 206 supports communications with other systems or devices. For example, the communications unit 206 can include a network interface card or a wireless transceiver facilitating communications over a wired or wireless network. The communications unit 206 may support communications through any suitable physical or wireless communication link(s). As a particular example, the communications unit 206 may support communication over the network(s) 104 of FIG. 1.

The I/O unit 208 allows for input and output of data. For example, the I/O unit 208 may provide a connection for user input through a keyboard, mouse, keypad, touchscreen, or other suitable input device. The I/O unit 208 may also send output to a display, printer, or other suitable output device. Note, however, that the I/O unit 208 may be omitted if the device 200 does not require local I/O, such as when the device 200 represents a server or other device that can be accessed remotely.

In some embodiments, the instructions executed by the processing device 202 include instructions that implement the functionality of the application server 106. Thus, for example, the instructions executed by the processing device 202 may cause the device 200 to perform various functions related to optimization with enhanced neural estimation. As particular examples, the instructions can cause the device 200 to receive a plurality of inputs including domain parameters and initial weights, provide the plurality of inputs to an optimization model, perform, using a first layer of the optimization model, a training and optimization process based on the plurality of inputs and based on a training objective, perform, using a second layer of the optimization model, a differencing operation on an output of the first layer, record, using a third layer of the optimization model, a loss based on the training objective used by the optimization model, calculate and store, using a fourth layer of the optimization model, metrics regarding the training and optimization process, and output, using the optimization model, updated weights. The instructions may also cause the device 200 to present one or more graphical user interfaces to users of the device 200, or to users of the electronic devices 102a-102d, such as one or more graphical user interfaces that allow a user to retrieve and view results of the optimization processes, such as presenting one or more results of portfolio predictions.

Although FIG. 2 illustrates one example of a device 200 supporting optimization with enhanced neural estimation, various changes may be made to FIG. 2. For example, computing and communication devices and systems come in a wide variety of configurations, and FIG. 2 does not limit this disclosure to any particular computing or communication device or system.

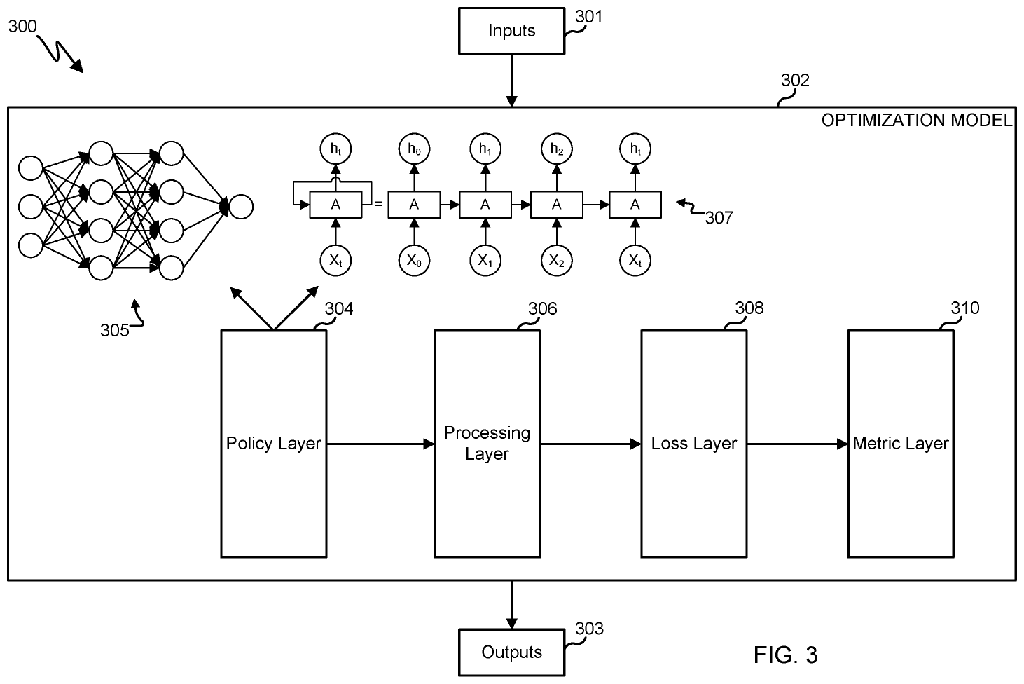

FIG. 3 illustrates an example functional architecture 300 for an optimization model 302 in accordance with this disclosure. For ease of explanation, the functional architecture 300 of FIG. 3 may be implemented using or provided by one or more applications 112 executed by the application server 106 of FIG. 1, and/or the database server 108, where the application server 106 and the database server 108 may be implemented using one or more devices 200 of FIG. 2. However, the functional architecture 300 may be implemented using or provided by any other suitable device(s), such as electronic devices 102a-102d, and in any other suitable system(s).

The architecture 300 includes the optimization model 302 that receives inputs 301 as described in the various embodiments of this disclosure, such as domain parameters, initial weights, and optional final weights, performs optimization on the inputs, and provides outputs 303, such as updated parameters or weights. The optimization model 302 is a neural network-based optimizer which models an unknown function ϕ(·) that maps from its input to the unknown arg minₓ f(x), where f is a desired objective function. The input x is a fixed constant x₀, so without loss of generality, let x₀=(1, 2, . . . , T), where T is a number of periods. Therefore, with each optimization, the neural network parameters are estimated so that ϕ is close to f. In this sense, there may be no one-time neural network parameter estimation, but there can be hyperparameters that pertain to the definition of ϕ.

First, ϕ is a neural network comprised in the optimization model 302 consisting of four layers. Neural networks are computational models inspired by the structure of the human brain in that they are similarly composed of a network of interconnected neurons that propagate information upon receiving sets of stimuli from neighboring neurons that approximate a mapping between inputs and outputs. Neural networks can be stacked using layers of neurons. There are various types of layers that can be used in networks, each suited for the type of data and features they are processing. For example, dense layers are often seen in regression problems and recurrent layers are often used in time series analysis.

The first layer of the optimization model 302 is a policy layer 304. In various embodiments, the policy layer 304 is direct search policy layer. Depending on the problem to be optimized using the optimization model 302, the policy layer 304 can take on different forms. For example, the policy layer 304 can be in a dense form 305, e.g., a dense neural network, or a recurrent form 307, e.g., a recurrent neural network (RNN). In the dense form 305, the policy layer 304 can be comprised of n_{layer} fully connected layers with m units. For example, when in the dense form 305, the policy layer 304 can be a dense layer feed-forward neural network, in which the neurons of the layer are connected to every neuron of its preceding layer. The neurons work as universal approximators, in that they can be trained to approximate any given nonlinear input-output mapping. Mathematically, even one hidden-layer multilayer perceptron (MLP) is able to approximate mappings arbitrarily close in the limit for any continuous function. The neurons prove their interpolation ability by generalizing even in sparse data space regions. In dense layers, a neuron consists of four parts: input values, weights and a bias, a weighted sum, and an activation function. The neurons work by taking in outputs from every neuron of its preceding layer. Next, it multiplies these inputs with the respective weights (this is known as the weighted sum).

These products are then added together along with the bias. The result of this computation is then passed onto an activation function, which will produce the output of the perceptron. Most activation functions are nonlinear, which play a determinant role in capturing non-linearity and improve the network's effectiveness. Without a nonlinear activation function, the outputs become a sum of simple linear functions, which still output a linear function. Hence the activation function enables the networks to create complex functions by using a combination of multiple neurons. Such activations functions can include, but are not limited to, a sigmoid function, a hyperbolic tangent (tanh) function, and a rectified linear unit (ReLU) function.

In a feed-forward neural network, the information only moves in one direction, from the input layer, through the hidden layers, to the output layer. The information moves straight through the network and never touches a node twice. Feedforward neural networks have no memory of the input they receive, and therefore, have no notion of order in time, but enables parallelization. The forward pass is used in a neural network inference step, while in a model fitting step, such as described in this disclosure, backpropagation is used. Backpropagation involves going backwards through the neural network to find the partial derivatives of the error with respect to the weights, which are then used by gradient descent, an algorithm that can iteratively minimize a given function. This allows the neural network to learn during the training process. A complete forward pass and backpropagation through an entire input dataset is called an epoch. The number of epochs is a hyperparameter that defines the number of times that the algorithm will work through the entire input dataset. In neural network training, there is typically a tradeoff between the maximum number of epochs and model precision.

In the recurrent form 307, the dense architecture is modified to include as input intermediary weights up to time t for t=1, . . . , T, as shown in FIG. 3. The output of the last layer is the sought after T×k tensor of weights, such as portfolio weights in some embodiments. RNNs are a class of neural networks that are helpful in modeling sequence data. Derived from feedforward networks, RNNs exhibit similar behavior to how human brains function with the addition of producing memories in output sequential data. Unlike feed-forward neural networks, in an RNN the information cycles through a loop. When an RNN makes a decision, it considers the current input and also what it has learned from the inputs it received previously. In other words, RNN has two inputs, the present and the recent past, and combines them to make predictions. This can be important for implementations such as to improve time series prediction because the sequence of data contains crucial information about what is coming next.

Furthermore, an RNN can tweak the weights for both gradient descent and backpropagation through time (BPTT). BPTT involves performing backpropagation on an unrolled RNN. Unrolling is a visualization and conceptual tool, which is illustrated by the recurrent form 307 in FIG. 3. FIG. 3 shows that an RNN can be seen as a sequence of neural networks, trained one after another with backpropagation. On the left of the visualization of the recurrent form 307 shown in FIG. 3, the RNN is unrolled after the equal sign. Note there is no cycle after the equal sign since the different time steps are visualized and information is passed from one time step to the next. Within BPTT the error is backpropagated from the last to the first-time step, while unrolling all the time steps. This allows calculating the error for each time step, which allows updating the weights.

The second layer of the optimization model 302 is a processing layer 306. The processing layer 306 performs parameter-free transformations on the output of the first layer 304, and, therefore, requires no calibration or estimation in various embodiments. The third layer is a loss layer 308. The loss layer 308 takes in an arbitrary function (the objective function) and records the loss. In various embodiments, the loss layer 308 does not have any parameters that require estimation. The fourth layer is a metric layer 310. The metric layer 310 calculates and stores down metrics regarding the optimization. These typically include various components of the objective function and, in some embodiments, constraint values.

As will be understood from this description of the optimization model 302, in some embodiments, the calibration and estimation performed pertain to the specific form of the first layer 304, that is, hyperparameters governing the number of layers and the number of units, and parameters related to the actual optimization process. The parameters can be selected based on the problem to be solved and other needs. In various embodiments, at the architecture level, these selectable parameters can include whether the first layer 304 is a dense network or a recurrent network, a number of hidden layers, a number of units per layer, kernel initializers, bias initializers, whether to use bias, and/or intermediary activation functions to use (sigmoid, tanh, ReLU, etc.). At the optimization level, selectable parameters for the optimization model 302 include an initial learning rate for a model fitting algorithm used by the optimization model, an exponential decay rate for first moment estimates, an exponential decay rate for second moment estimates, a numerical stability constant (e.g., a very small number to prevent any division by zero in the implementation), a minimum delta value for early stopping convergence criterion, and/or a maximum number of epochs.

To perform these calibrations on the optimization model 302, a search space of hyperparameters can be defined, for example, according to Table 1, shown below.

TABLE 1

| Parameters | Values |
|---|---|
| Dense vs. Recurrent | {Dense, Recurrent} |
| Number of hidden layers | {3, 4, 5} |
| Number of units per layer | {8, 16, 32} |
| Epochs | {100, 500, 1,000, 5,000, 10,000} |

As a pre-step to addressing the main optimization problem, a trial-optimization problem can be run to determine the hyperparameters, which leads to a good balance of convergence speed and accuracy. These parameters can then be fixed, such as fixing the parameters to be used for a multi-period portfolio. In some embodiments, a default optimization model 302 can be set, such as a default model using 4 dense hidden layers and 16 units per layer. As shown in Table 1 above, in some embodiments, the optimization model 302 is fitted with a maximum of 10,000 epochs. In some embodiments, weight and bias can both be initialized using a He uniform variance scaling initialization method.

In various embodiments, the optimization model 302 performs a training/optimization process using the inputs 301 (which can include data and model parameters/weights from feeder models), in order to find network trainable weights that minimize a loss function, as defined by the optimization process, in a highly efficient manner. Selection of such an optimization process to achieve the trained/optimized weights while retaining efficiency is a key consideration. For example, multi-period portfolio optimization with constraints on weights of securities in a portfolio is a high-dimensional optimization problem, which cannot be solved by traditional convex optimization techniques, such as quadratic programming. Furthermore, computational time can grow exponentially with increases in dimensions if using non-linear optimization algorithms to solve the problem. The optimization model 302, however, is more computationally efficient and can scale in time in dimension (number of assets) because it can leverage stochastic optimization. For example, with an increasing number of assets in a portfolio, the computational time for fitting using the optimization model 302 keep at a similar level.

As one example, the optimization model 302 can perform a model fitting process, such as the Adam optimization algorithm. The model fitting process fits neural networks with backpropagation or BPTT. In some embodiments, the model fitting process is an extension to stochastic gradient descent. Stochastic gradient descent involves using a single learning rate for weight updates, and the learning rate for each network parameter (each weight) does not change during training. The model fitting process used by the optimization model 302, however, can adapt the parameter learning rates in real time based on the average of the first and second moments by calculating an exponential moving average of the gradient as well as the squared gradient. For example, the aggregate gradients at time t, mₜ can be expressed as shown in Equation (1) below.

$${m}_{t} = {β}_{1} {m}_{t - 1} + ( 1 - {β}_{1} ) \frac{\partial L}{\partial {θ}_{t}} \qquad ( 1 )$$

where L is the loss function and θₜ is the parameter in the neural network.

In addition to the cumulative sum of gradients, the model fitting process also takes the moving weighted average of squared gradients vₜ which can be expressed as shown in Equation (2) below.

$${v}_{t} = {β}_{2} {v}_{t - 1} + ( 1 - {β}_{2} ) {( \frac{\partial L}{\partial {θ}_{t}} )}^{2} \qquad ( 2 )$$

The parameters β₁ and β₂ can control the decay rates of both moving averages. In some embodiments, default values can be used, such as β₁=0.9 and β₁=0.999. Since, mₜ and vₜ can both be initialized as 0, they can be biased towards 0 as both β₁ and β₂ close to 1. The optimization model 302 addresses this problem by computing bias-corrected mₜ and vₜ. This bias-correction is also performed to control the weights while reaching the global minimum to prevent high oscillations when near the global minimum, which can be expressed as shown in Equation (3) below.

$${\hat{m}}_{t} = \frac{{m}_{t}}{1 - {β}_{1}^{t}} , {\hat{v}}_{t} = \frac{{v}_{t}}{1 - {β}_{2}^{t}} \qquad ( 3 )$$

The optimization model 302, as part of the model fitting process, then takes the bias-corrected weight parameters \hat{m}ₜ and îₜ to update parameters in the neural networks, which can be expressed as shown in Equation (4) below.

$${θ}_{t - 1} = {θ}_{t} - {\hat{m}}_{t} \frac{lr}{\sqrt{{\hat{v}}_{t}} + ϵ} \qquad ( 4 )$$

where lr is the learning rate, which can have a default of 0.001, and ε is a small positive constant, such as 10⁻⁸, for numerical stability.

The optimization model 302 executes backpropagation coupled with the above optimization process in order to find the neural network trainable weights that minimize its loss function. The loss function of the optimization model 304 is set to the objective function \tilde{f}. The output of the neural network is the set of portfolio weights W*=argmin_{w}\tilde{f}(W). In some embodiments, input information, such as market input information, is already embedded in \tilde{f} and, therefore, the optimization model 302 fits a neural network specific to the objective. In order to have a well-defined neural network model, an input is provided to execute the forward pass through the network. In various embodiments, let this input x₀ vary per optimization problem with the number of periods in the multi-period optimization, so the capacity of the network can organically increase with the difficulty of the problem (more time periods can use a more complicated network). Therefore, the input is defined to be the time vector for the problem corresponding to the T periods in the multi-period optimization, thus x₀=(1, . . . , T). This is akin to inputting a vector of states to the optimization problem, where the only state information is the time period. As optimization problems increase in difficulty, additional information can be incorporated into these states.

With these inputs and outputs in mind, the custom policy layer 304, in which neural network trainable parameters are located, takes in x₀ as input and returns W*. The second layer, the processing layer 306, is a parameter-free custom layer used to apply a static differencing operation on W* to obtain the information such as trades for each period. The third and fourth layers, the loss layer 308 and the metric layer 310, are custom parameter-free layers used to record the loss function value and any relevant metrics, respectively. Incidentally, these custom layers are included in the optimization model 302 to allow for flexibility in defining arbitrary tensor-based loss functions and metrics operating on weights (such as portfolio weights) or differences in weights corresponding to the optimization objective and constraints without changing the architecture of the neural network.

The policy layer 304, in various embodiments, is the layer with trainable parameters that change during fitting. The input x₀ is passed through a sequence of several layers (such as dense or recurrent layers) to finally yield the W* that minimizes the objective function. The definition of this architecture can also be dynamically adjusted by the model to correspond to user-specified hard constraints. While soft constraints are embedded in \tilde{f}, certain classes of hard constraints are captured directly in the definition of this custom layer, thereby simplifying the fitting problem significantly. For example, if a hard constraint is specified that no short and no levered positions are allowed and that the entire portfolio is fully invested (weights sum to 1), applying a softmax activation function before returning the result ensures the constraints are satisfied by design. Additionally, this architecture has the benefit of aiding the fitting problem and increasing convergence speed by acting as additional regularization.

Additionally, given the neural network, the optimization process is reduced to constructing the neural network loss function by user-specified inputs (such as market inputs including returns, risks, volumes, etc.) that define the objective function and optionally combining this with any user-specified soft constraints. The model then uses a batch of 1 x₀ to propagate and backpropagate through the network a numbered epoch of times, corresponding to one iteration of optimization model 302. A maximum number of epochs and an early stopping criterion based on the loss function default to reasonable values, but can be adjusted to trade off optimization time and precision. When the loss function stops decreasing significantly with every epoch, the model has converged and has found the trainable parameters of the neural network which allow mapping from x₀ into the optimal weights W*.

Two other important points are worth noting here about the optimization model 302. First, despite the optimization model 302 using neural networks, the optimization model is unique in that the training/learning objective of the optimization model 302 is not to achieve a resulting neural network that performs well out of sample. Rather, it is the fitting process that is the focus of the optimization model 302, as this gives the weights which optimize the objective/constraints. Second, the fitting process is performed not only for any changes to the objective functions and constraints (such as adding a constraint, changing the risk sensitivity), but also to the underlying data (such as market data including returns, risk, etc.), as together these define the loss function of the neural network and, therefore, change the problem, and thus define any change to the optimization problem.

Although FIG. 3 illustrates one example functional architecture 300 for an optimization model 302, various changes may be made to FIG. 3. For example, various components and functions in FIG. 3 may be combined, further subdivided, replicated, or rearranged according to particular needs. Also, one or more additional components and functions may be included if needed or desired. Computing architectures and machine learning architectures can come in a wide variety of configurations, and FIG. 3 do not limit this disclosure to any particular computing architecture or machine learning architecture. For instance, the components of the architecture 300 illustrated in FIG. 3 could be shown as being executed on a single electronic device, such as one of electronic devices 102a-102d, by one or more cloud servers, such as by one or more of the application server 106 and/or database server 108, or a combination of electronic devices and servers in a distributed environment. For instance, inputs 301 provided to the optimization model 302 could be provided by an electronic device such as one of the electronic devices 102a-102d, with the inputs being transmitted over a network to one or more remote servers, such as the application server 106 and/or the database server 108, with the one or more remote servers executing the optimization model 302 to provide outputs 303 that are then transmitted back to the electronic device that provided the inputs 301.

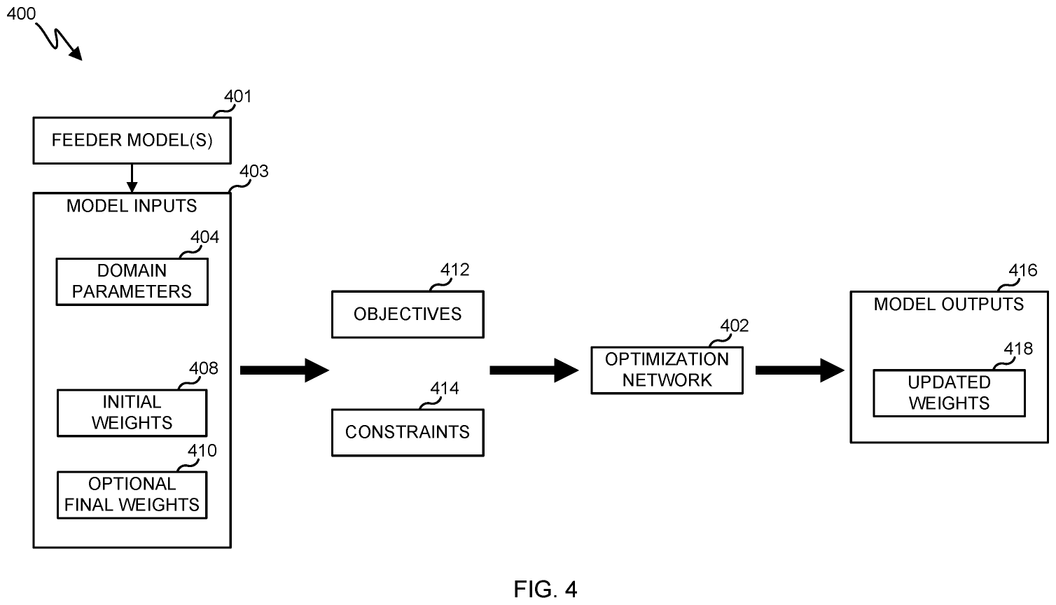

FIG. 4 illustrates an example optimization model process 400 in accordance with this disclosure. For ease of explanation, the process 400 is described as involving the use of the one or more applications 112 executed by the application server 106 of FIG. 1, and/or the database server 108, where the application server 106 and the database server 108 may be implemented using one or more devices 200 of FIG. 2. However, the process 400 may be performed using any other suitable device(s), such as an electronic device like electronic devices 102a-102d, and in any other suitable system(s).

As shown in FIG. 4, at a first step, a feeder model 401 provides model inputs 403 that are to be used by an optimization network 402, e.g., the optimization model 302 described above. The model inputs 403 can include various inputs such as domain parameters 404, such as parameters related to a specific domain, industry, and/or problem to be solved. The model inputs 403 also include initial weights 408 that are provided by the feeder model 401 and are weights used by the feeder model 401 in performing predictions. Optionally, the model inputs 403 can include optional final weights 410 that can be provided to be applied to rebalancing problems where the end results are given, but the path to get there is found by the optimization network 402, which can provide various benefits such as reducing transaction costs of the neural network based on new weights provided by the optimization network 402.

At a next step, as shown in FIG. 4, objectives 412 and constraints 414 are defined for the optimization to be performed by the optimization network 402. The optimization network 402, as described in this disclosure, is a neural network-based optimizer capable of performing optimization for large dimensional problems, handling complex highly non-linear real-world constraints and solving optimization problems where the objective functions 412 or constraints 414 can involve stochastic parameters. For a large number of assets, the optimization network 402 has been found to outperform traditional non-linear optimization packages by many orders of magnitude (up to 1,000 times), able to produce results in minutes that would take weeks otherwise. Overall, the model is robust and works with a broad spectrum of objective functions 412 and constraints 414. For certain problems where convex optimization solutions exist, the optimization network 402 matches the results with high precision. Model outputs 416 provided by the optimization network 402 has also been found to be numerically stable. The model outputs 416, in various embodiments, include updated weights 418 created using at least the initial weights 408 by performing the backpropagation and optimization processes described in this disclosure. In some embodiments, the updated weights 418 then can be used by the feeder model 401 to provide optimized and more accurate predictions. In some embodiments, predictions optimized by the optimization network 402 can be output as part of the model outputs 416.

Although FIG. 4 illustrates one example of an optimization model process 400, various changes may be made to FIG. 4. For example, various components and functions in FIG. 4 may be combined, further subdivided, replicated, or rearranged according to particular needs. Also, one or more additional components and functions may be included if needed or desired. Computing systems, machine learning systems, and related processes come in a wide variety of configurations, and FIG. 4 does not limit this disclosure to any particular computing system, machine learning system, or related process. For instance, the steps of the process 400 illustrated in FIG. 4 could be shown as being executed on a single electronic device, such as one of electronic devices 102a-102d, by one or more cloud servers, such as by one or more of the application server 106 and/or database server 108, or a combination of electronic devices and servers in a distributed environment. For instance, model inputs 403 provided to the optimization network 402 could be provided by an electronic device that executed the feeder model 401, such as one of the electronic devices 102a-102d, with the inputs 403 being transmitted over a network to one or more remote servers, such as the application server 106 and/or the database server 108, with the one or more remote servers executing the optimization network 402 to provide outputs 416 that are then transmitted back to the electronic device that provided the inputs 403.

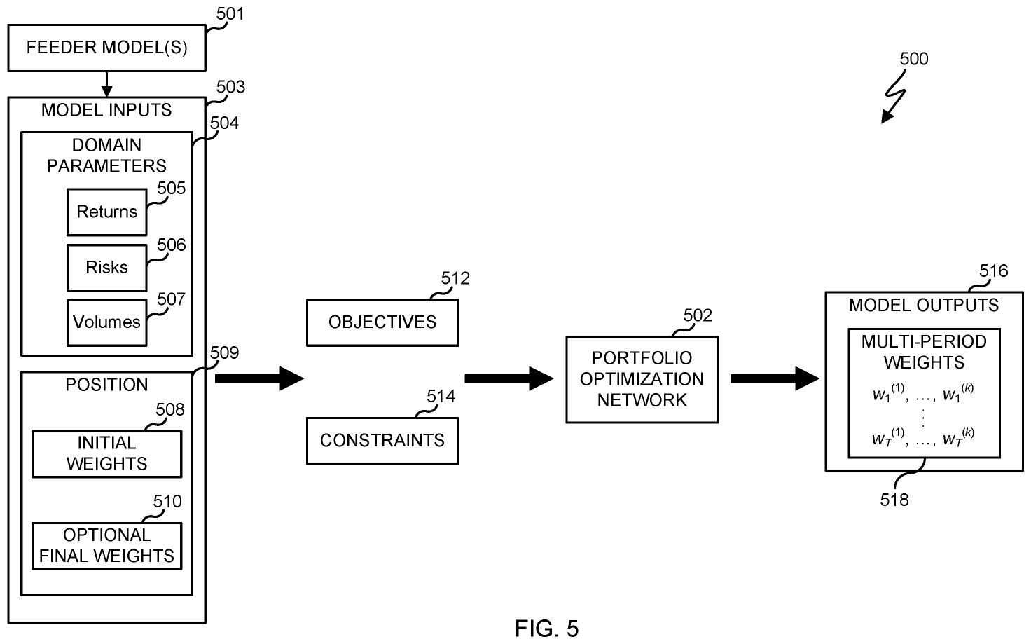

FIG. 5 illustrates an example portfolio optimization model process 500 in accordance with this disclosure. For ease of explanation, the process 500 is described as involving the use of the one or more applications 112 executed by the application server 106 of FIG. 1, and/or the database server 108, where the application server 106 and the database server 108 may be implemented using one or more devices 200 of FIG. 2. However, the process 500 may be performed using any other suitable device(s), such as an electronic device like electronic devices 102a-102d, and in any other suitable system(s).

As shown in FIG. 5, at a first step, a feeder model 501 provides model inputs 503 that are to be used by a portfolio optimization network 502, e.g., the optimization model 302 or the optimization network 402 described above. The model inputs 503 can include various inputs such as domain parameters 504, such as parameters related to a specific domain, industry, and/or problem to be solved. For instance, in this example, the domain parameters are related to market data and include inputs such as returns 505, risks 506, and volumes 507. The model inputs 503 also include initial weights 508 that are provided by the feeder model 501 and are weights used by the feeder model 501 in performing inferencing and predictions. Optionally, the model inputs 503 can include optional final weights 510 that can be provided to be applied to rebalancing problems where the end results are given, but the path to get there is found by the portfolio optimization network 502, which can provide various benefits such as reducing transaction costs of the neural network based on new weights provided by the portfolio optimization network 502.

In this example, the portfolio optimization network 502 is used to optimize portfolio predictions. As shown in FIG. 5, the portfolio optimization network 502 can use five categories of inputs and optimization conditions: projections of future returns 506, equity volumes 507 and risks 506, such as in the form of variance-covariance matrix, current positions/holdings 509, objectives 512 such as benchmarks and volume estimations, and portfolio/account constraints 514. All these inputs can be defined for each period (such as each day). In various embodiments, inputs to the portfolio optimization network 502 will be generated by one or more feeder models 501 already approved and used by risk management operations. The model inputs 503 can be provided at the first step, and, at a next step, as shown in FIG. 5, the objectives 512 and the constraints 514 can be defined and/or input for the optimization to be performed by the portfolio optimization network 502. At a next step, the optimization network 502 performs the optimization using the inputs.

At a next step, the outputs 516 are provided by the portfolio optimization network 502. In this example, the outputs 516 of the model include updated weights 518 optimized using the domain parameters 504, the position parameters 509 (initial weights 508 and optional final weights 510). For example, the updated weights 518 can be multi-period weights of the portfolio for each day. The updated weights 518 are created using at least the initial weights 508 by performing the backpropagation and optimization processes described in this disclosure. In some embodiments, the updated weights 518 then can be used by the feeder model 501 to provide optimized and more accurate predictions. In some embodiments, predictions optimized by the portfolio optimization network 502 can be output as part of the model outputs 516.

The model inputs 503 provided by the one or more feeder models 501 and used by the neural optimizer can depend on the objective function and constraints of the specific optimization problem. For a multi-period portfolio optimization, for example, the inputs 503 will typically include the list of assets with the corresponding forecasts of returns 505, risk 506, and volumes 507. Specifically, in such embodiments, inputs can include: expected future returns for individual assets 505 (uₜ), an expected future variance-covariance matrix 506 for the assets (Et), and expected future traded volumes 507 for the individual assets (vₜ).

In addition to the multi-period portfolio optimization, the optimization model of the various embodiments of this disclosure can handle multiple other optimization processes, such as alpha harvesting, portfolio rebalancing, portfolio replication, etc. Depending on the type of optimization problem to be solved, the portfolio optimization model 502 can receive deterministic parameters (uₜ, Σₜ, vₜ) that are known in advance, or the optimization model 502 can use stochastic parameters (uₜ, Σₜ, vₜ) that are impacted by either broad exogenous random factors (e.g., overall volatility or liquidity of the market during that period) or at an endogenous level. For example, vₜ can be a random vector with a given distribution.

Depending on the type of portfolio optimization problem/objective 512 (alpha harvesting, portfolio rebalancing, portfolio replication, etc.), the initial weights 508 and/or the final weights 510 of the portfolio, or weights of a benchmark portfolio, could be provided as the inputs 503. Similarly, additional parameters or metadata specifying portfolio constraints 514 could be provided. For example, risk concentration by industry can use input parameters specifying the threshold on concentration and additional data can thus be used to map each asset to the corresponding industry. For deterministic inputs, the future returns 505, covariance matrices 506, and volumes 507 can be given for each period. For example, a one-month optimization with daily changes in the portfolio can use projections of returns, risk and volumes for each day during the month. Therefore, standard inputs can be asset vectors (for returns and volumes) or matrices (for risk) with an additional time dependency. These inputs 503 can be generated by alpha and risk feeder models 501 that can be previously validated for use.

In some embodiments, for input data, the optimization network 502 can apply checks to ensure input data consistency. For example, the optimizer may expect that the projected returns and volumes are in a certain range (e.g., projected volumes are not negative) and that the variance-covariance matrix is positive semidefinite. In some embodiments, the model can conduct a data quality check to check consistency of the number of securities (the number and order of securities appearing in all inputs should be consistent), a validity check of volume (all of the volumes should be non-negative), a positive definite check of the variance-covariance matrix (the input variance-covariance matrix should be positive definite), a feasibility check of constraints (constraints should be feasible where the solution for weights should exist), and a boundless check of the inputs 503 (market information inputs should not be infinite, position weights inputs should sum to 1).

In some embodiments, a key assumption of the optimization network 502 is that the local optimal solution found by the model is close to the true global solution of the problem even when the dimensionality of the problem is large. It has been found that the outputs 516 of the optimization model 502 for high-dimensional one-step mean-variance optimization problems to the global solution results in outputs of the models that are extremely close. For multi-step optimizations, results have shown that the optimization network 502 significantly benchmarks such as the Monte Carlo benchmark. In some embodiments, another key assumption is that the output of the optimization network 502, which relies on numerical techniques and algorithms, is numerically stable, and numerical stability of the optimization network 502 has been found to be the case.

Additionally, in the example of FIG. 5 in which the optimization network 502 is used for optimizing market and portfolio predictions, there can be several assumptions associated with the market impact of trading activity. For example, an assumption can be that the market impact is a non-linear function of trade size and inversely proportional to the average daily traded volume. Another assumption can be that market impact lasts for several trading periods and reverts slowly and asymptotically converges to a fraction of the first day impact (i.e., to the long-term trading impact threshold). Another assumption can be that the model inherits all assumptions from its feeder models 501. That is, if assumptions related to the input data of the optimizer 502 are violated (such as those related to alpha projections, daily volumes, risk, etc.), the optimization results may be negatively affected.

In some embodiments, the target users of, or beneficiaries of the results provided by, the portfolio optimization network 502 are equity review, asset management, and/or asset trading personnel. Such personnel can use various quantitative strategies to manage clients' equity portfolios. The quantitative strategy adopted by such personnel can aim to generate excess returns by customizing portfolio exposure to selected factors. Personnel responsible for optimal execution of trades for can manage equity trades involving large total trading values per day. Considering the size of some portfolios and daily traded volumes, transaction costs of trading due to market impact can be material and are ripe for optimization using the optimization network 502. The portfolio optimization network 502 can provide multi-period optimizations (such as the multi-period weights 518) to reduce transaction costs by taking these multi-period outputs provided by the portfolio optimization network 502 into consideration for decisions made by such personnel.

The optimization performed by the optimization model 502 is a process by which inputs, such as inputs 503, are sought in a given search space in order to maximize or minimize a given function or objective, such as objectives 512. Constrained optimizations, such as using constraints 514, further restrict the search space by requiring that additional equalities and/or inequalities hold for the optimization solution. Optimization methods can be described in terms of global and local optimization. The aim of global optimization is to find the minima or maxima across the entire search space should they exist. To achieve the best solution, searching is performed globally in each dimension of the objective function. Existing global optimizations include uniform grid search, complete (enumerative) search strategies and successive approximation methods. These existing methods are convergent under mild assumptions, but are not practical in higher-dimensional problems because the computation cost grows exponentially as dimension increases. Unlike global optimization which finds the best solution over the given set, local optimization seeks to find a solution that is optimal within a neighboring set of candidate solutions in order to reduce the computational cost. Existing local search algorithms, which belong to deterministic optimization, such as Nelder-Mead and Broyden-Fletcher-Goldfarb-Shanno (BFGS) algorithms, will often find locally optimal solutions of varying quality, that is, easily be trapped by local minima depending on the starting point of the search.

The optimization model of the various embodiments of this disclosure, including optimization network 502, however, includes stochastic optimization, which avoids the local optima traps, and introduces randomness in the process. This permits less optimal local decisions to be made within the search procedure that may increase the probability of locating the global optimum of the objective function. This is achieved by the optimization model 502 taking locally suboptimal steps or moves in the search space that allow it to escape local optima. Use of randomness in the stochastic optimization performed by the optimization network 502 does not mean that the algorithm is random. Rather, it means that some decisions made during the search procedure involve some portion of randomness. For example, the move from the current to the next point in the search space made by the portfolio optimization network 502 may be made according to a probability distribution relative to the optimal move.

In various embodiments, the portfolio optimization network 502 is a stochastic local optimizer implemented using a neural network framework. The portfolio optimization network 502 starts from an arbitrary point and searches for an optimal solution. Inherent stochasticity built into the neural network formulation (such as stochastic gradient descent, stochastic weight initialization) makes the algorithm more likely to escape local extreme points. Although, there may be no guarantee to find the global optima, the optimization results of the portfolio optimization network 502 have been found to be prone to be more stable and less dependent on initial values than traditional local optimizers. Thus, the portfolio optimization network 502 calculates gradients and performs direct search in a highly efficient manner.

Particularly, when the portfolio optimization network 502 is used to the output multi-period weights 518, the portfolio optimization network 502 aims to find a set of securities' weights for each period to achieve the maximum net return for a given risk appetite of a portfolio in the presence of a multi-period market impact. An objective function of the objectives 512 can include three parts: total portfolio return (aiming to maximize the weighted sum of expected asset returns across multiple periods that is sourced from one or more feeder models 501), total portfolio risk (aiming to minimize the portfolio risk, which is the weighted sum of expected an asset-asset variance covariance matrix across multiple periods, for a given risk appetite that is sourced from one or more feeder models 501), and total market impact (aiming to minimize the loss of portfolio returns due to short and long term impact of trading securities) as discussed below.

In various embodiments, using the optimization network 502 includes denoting portfolio weights wₜ=(wₜ⁽¹⁾, wₜ⁽²⁾ . . . , wₜ⁽ⁱ⁾, . . . , wₜ^{(k)}) at a time t, where t takes values in t=0, . . . , T for a fixed, known, T for the k assets in the portfolio, and W=(w₁, . . . , W_{T})^{T}. Let μₜ=(μₜ⁽¹⁾, . . . , μₜ^{(k)}) be the vector of expected returns for individual assets at time t, where the expected total return of the portfolio across all periods is μₜₒₜ(W)=Σₜ₌₁^{T}wₜ^{T}μₜ. Σ can be defined as the variance-covariance matrix of the assets, and the portfolio's risk at time/can be expressed as shown in Equation (5) below.

$${σ}_{t} ( {w}_{t} ) = \sqrt{{w}_{t}^{T} {\sum }_{t} {W}_{t}} \qquad ( 5 )$$

Similarly, the total risk can be defined as the sum across all periods, which can be expressed as shown in Equation (6) below.

$${σ}_{t o t} ( W ) = \sqrt{{Σ}_{r = 1}^{T} {σ}_{r}^{2} ( {w}_{r} )} \qquad ( 6 )$$

In addition to risk and return, the portfolio optimization network 502 can consider transaction costs stemming from market impact of trades for multi-period portfolio optimization, which are commonly ignored in one-period portfolio optimization approaches. Transaction costs can include two terms: instantaneous effect and long-term impact of trading. The portfolio transaction costs can be assumed to be additive across assets and time, with time dependency being captured by long term impacts. The total transaction cost can be denoted as τₜₒₜ(W). In some embodiments, the optimization problem to be solved using the portfolio optimization network 502 can be written as the following optimization problem:

$${min}_{w} f ( w ) = - {μ}_{tot} ( W ) + {γ}_{1} {σ}_{tot} ( W ) + {γ}_{2} {τ}_{tot} ( W )$$

$$s . t . {w}_{0} = {w}_{init}$$

$${w}_{T} = {w}_{fin} ( optional )$$

$${\sum }_{i = 1}^{k} {w}_{t}^{( i )} = 1 , t = 1 , … , T$$

$$0 \leq {w}_{t}^{( i )} \leq 1 , t = 1 , … , T , and , i = 1 , … , k$$

where γ₁≥0 is the risk sensitivity and γ₂≥0 is transaction cost sensitivity, which can be calibrated from empirical observations to reflect true deterioration in alpha due to high value trades.

The first constraint (initial weights 508) shown above, states that the “day 0” portfolio is given, and this is used to assess the first day's trade impact. The second constraint (final weights 510) shown above is optional, and can be applied to rebalancing problems where the end portfolio is given, but the path to get there is found by the portfolio optimization network 502. In some embodiments, if the optional final target portfolio weights are not provided, the multi-period portfolio optimization performed using the portfolio optimization network 502 becomes an alpha-harvesting problem that seeks excess returns for given forecasting. In some embodiments, if the optional final target portfolio weights are provided, the optimization problem can become a rebalancing problem implemented across multiple periods to reduce the transaction cost. The third constraint shown above indicates that the security weights in a portfolio always sum to 1 throughout the optimization periods. In some embodiments, the last constraint shown above confines the portfolio to consider no leverage and no short. The last two constraints can be easily relaxed in the framework if one wants to allow for shorting and leverage.

In practice, portfolio managers can use additional constraints either due to investment views or internal guidelines. Therefore, these soft constraints can be incorporated directly in the objective function via a soft constraint penalty function, fₚₑₙ. Also, in the portfolio optimization network 502, these constraints can be taken to be arbitrary functions operating on the weights w, but in some embodiments can be restricted to linear min-max constraints, which can be expressed as shown in Equations (7) and (8) below.

$${min}_{w} \tilde{f} ( W ) = - {u}_{t o t} ( W ) + {γ}_{1} {σ}_{t o t} ( W ) + {γ}_{2} {τ}_{tot} ( W ) + λ {\sum }_{t = 1}^{T} {f}_{p e n} ( {w}_{t} ; l , u ) \qquad ( 7 )$$

where λ≥0 is the soft constraints sensitivity.

$${f}_{p e n} ( {w}_{t} ; l , u ) = max ( 0 , l - {w}_{t} ) + max ( 0 , {w}_{t} - u ) \qquad ( 8 )$$

where max is taken component-wise, l and u are vectors for minimum and maximum weight constraints, respectively.

With respect to transaction costs, there are several types of costs that can be involved in implementing a long/short equity strategy, such as leverage costs (funding spreads paid on long positions and shorting fees paid on short positions), dividend withholding taxes (that negatively impact long positions) and trading costs (commissions paid to brokers and market impact). Among these costs, market impact costs, including instantaneous market impact and long-term impact, are important to quantitative asset managers because they increase more than proportionally to the capital allocated to a trading strategy. The other costs are proportional to the capital allocated and shift down net returns by the same percentage. Properly controlling for these costs using optimization techniques can enhance portfolio performance significantly. For a large enough order size, also called a “metaorder,” a main component of transaction costs comes in the form of market impact, which can be measured as the difference between the average execution price of an order and the price prevailing before the start of the order. Market impact can decay slowly (over multiple days) and revert, possibly incompletely, once a metaorder is executed. This has implications for estimating transaction costs.

For example, when splitting large capital for a target portfolio into several trades, this results in auto-correlation in execution prices of the trades. Neglecting the slow decay of market impact on past trades will underestimate trading costs and possibly lead to wrong decisions about scheduling trades. To illustrate the effect of market impact on orders, consider a large institutional metaorder for buying stock A in the presence of liquidity constraints which preclude the entire order being completed in one day. Instead, the order needs to be split equally over two days, with an estimated market impact for each trade of 10 bps. A single-period transaction cost model would presume that market impact reverts fully after an order is executed. That is, total market impact costs would yield 50%×10 bps+50%×10 bps=10 bps for buying stock A over the two days. In fact, this underestimates the second day's cost, which should be more than 10 bps.

Since the first day of orders will drive stock A's price up, this impact will have only slightly reversed on the second day. For the sake of simplicity, assume that, before the market opens on the second day, the price reverts 2 bps from the previous day. Then, the true market impact cost of buying stock A in the second day is 10−2+10=18 bps. The total market impact cost to do the whole trade is therefore 50%×10+50%×18 bps=14 bps, which is higher than 10 bps. The root of underestimating trading costs arises from ignoring the slow decay of the market impact and leads to overoptimistic of cost estimation. Although it is true that splitting a metaorder over multiple periods can reduce transaction cost, the benefit of order splitting is likely to be overstated if one assumes the market fully reverses before the next period. Once the slow decay of market impact is considered, as illustrated in the above example, this order splitting might not lower the transaction cost by the intended amount.

Regarding instantaneous market impact, in some cases the impact of large trades on equity market prices has been found to follows a concave power function of trade size over average daily volume, as indicated in various literature. In some cases, a concave market impact has been found in rough agreement with a square root formula. In addition, market impact can be studied from two different perspectives. The first one addresses the effect of a metaorder being executed on the price formation process. This effect is commonly termed the temporary market impact, which is an important explanatory variable of the price discovery. Temporary market impact is the main source of trading costs, and models based on empirical measurements can be used in optimal trading schemes, or used by an investment firm in order to understand its trading costs. In various embodiments, the portfolio optimization model 502 lets market impact approximately increase as the square root of trade size. That is, the instantaneous market impact of a metaorder per unit for given portfolio with market cap C, in dollar terms, can be expressed using the Square Root Law, which can be expressed as shown in Equation (9) below:

$${τ}_{t}^{( i )} = {κ}^{( i )} \sqrt{\frac{\vert {w}_{t}^{( i )} - {w}_{t - 1}^{( i )} \vert \times C}{{v}_{t}^{( i )}}} \qquad ( 9 )$$

where κ⁽ⁱ⁾ is a parameter that optionally depends on security i's average daily volatility and is calibrated from empirical data, vₜ⁽ⁱ⁾ is the average daily traded volume of the security i on period t, and κ⁽ⁱ⁾ can vary from security to security but assumed to be the same across periods.

In some cases, empirical estimates have shown κ=10. As such, in some embodiments, the portfolio optimization model 502 can include κ as a constant for all securities. Given that the constant for κ will be affected by portfolio market cap C, κ can be 1.0 and the rest of it to be absorbed into market impact sensitivity γ₂. It will be understood that, in some embodiments, this choice of κ is not relevant in evaluation portfolio optimization network 502, as a portfolio manager-defined transaction cost sensitivity (γ₂) calibrated to the universe of traded securities can be used. Relevant in such cases is the non-linear functional dependence on traded capital as a percent of daily volume.

Market impact can also pertain to the persistence of a shift in the price after the metaorder is fully executed, called the long-term market impact, which reflects the price reversion after the executed metaorders. It has been found that long-term market impact can be a square root function of trade duration. Additionally, the decay of market impact can take place as soon as the metaorder completes. While at the end of the same day decay is on average ⅔ of the peak impact, the decay continues the next days, following a power-law function at short time scales, and converges to ½ of the impact at the end of the first day at long time periods around 50 days. Similar behaviors have been observed, that is, market impact slowly converges to a fraction of the first day impact (the “permanent” impact), as indicated in various literature. This slow decay of market impact leads to significantly higher buying cost to the latter trades and thus can be important to modeling when optimizing portfolios.

Considering the above regarding long-term market impact and decay, in various embodiments, the portfolio optimization network 502 can calibrate the decay of market impact of a metaorder executed on t and the long-term market impact measured on time t′ to be expressed as shown in Equation (10) below:

$$δ ( t , {t}^{′} ) = {I}_{\{ t \leq t ′ \}} \cdot \{ {p}_{∞} + ( 1 - {p}_{∞} ) {e}^{- n ( {t}^{′} - t )} [ \sqrt{1 + ( {t}^{′} - t )} - \sqrt{{t}^{′} - t} ] \} \qquad ( 10 )$$

where I_{{t≤t′}} is an indicator function taking value 1 when t≤t′ and 0 otherwise, p∞ is the permanent price impact as t→∞, and η is a parameter that controls the decay speed.

In some embodiments of this disclosure, the permanent impact can be considered 0 for simplicity (reversal occurs slower than the number of periods considered) and η=0.05 is chosen so the impact goes to 50% of original after ˜10 days, which is consistent with empirical observations. In some cases, it has been observed that stock price accumulates sharply as trade continues and will not revert to its permanent price on the second day. The longer the trade period, the higher the price of the asset and thus the higher cost of trade. In addition, it will take much more time for the price to revert to permanent price if the duration of the trades is longer, representing the slow decay of extended market impact. Therefore, the total market impact can be expressed as shown in Equation (11) below:

$${τ}_{tot} ( W ) = {\sum }_{i = 1}^{k} {\sum }_{{t}^{′} = 1}^{T} ( {w}_{t ′}^{( i )} - {w}_{{t}^{′} - 1}^{( i )} ) {\sum }_{t = 1}^{t ′} δ ( t , {t}^{′} ) \cdot {τ}_{t}^{( i )} \qquad ( 11 )$$

Regarding daily traded volume, to calculate transaction cost, some projection of average daily volume can be used. Unlike transaction cost, which is part of the objective function portfolio optimization network 502, the projection of volume can be used as a feeder model 501. In some embodiments, volume can be predicted using approaches including moving averages or complex standalone volume models. The portfolio optimization network 502 can work with any type of volume models as feeder models 501, with outputs being either deterministic volume data or projection of certain distributions of volumes.

As described in this disclosure, such as with respect to FIG. 3 and with respect to Equations (1)-(4), the portfolio optimization model 502 uses an optimization/fitting process to optimize the inputs 503 provided to the portfolio optimization model 502 to provide for updated and enhanced parameters, such as the multi-period weights 518, to be used for more accurate portfolio predictions. As described above, the process 500 includes constructing the neural network loss function by user-specified market inputs (returns, risks, volumes) that define the portfolio objective function and optionally combining this with any user-specified soft constraints. The model then uses a batch of 1 x₀ to propagate and backpropagate through the network a number of times (epochs), corresponding to one iteration of the portfolio optimization model 502. In some embodiments, a maximum number of epochs and an early stopping criterion based on the loss function default to reasonable values, but can be adjusted to trade off optimization time and precision. When the loss function stops decreasing significantly with every epoch, the model has converged and has found the trainable parameters of the neural network which allows mapping from x₀ into the optimal weights W*.

Two other important points are worth noting here about the optimization model 502. First, despite the portfolio optimization network 502 using neural networks, the optimization model is unique in that the training/learning objective of the portfolio optimization network 502 is not to achieve a resulting neural network that performs well out of sample. Rather, it is the fitting process that is the focus of the optimization model 502, as this gives the weights which optimize the objective/constraints. Second, the fitting process is performed not only for any changes to the objective functions and constraints (such as adding a constraint, changing the risk sensitivity), but also to the underlying data (such as market data including returns, risk, etc.), as together these define the loss function of the neural network and, therefore, change the problem, and thus any change to the optimization problem.

Although FIG. 5 illustrates one example of a portfolio optimization model process 500, various changes may be made to FIG. 5. For example, various components and functions in FIG. 5 may be combined, further subdivided, replicated, or rearranged according to particular needs. Also, one or more additional components and functions may be included if needed or desired. Computing systems, machine learning systems, and related processes come in a wide variety of configurations, and FIG. 5 does not limit this disclosure to any particular computing system, machine learning system, or related process. For instance, the steps of the process 500 illustrated in FIG. 5 could be shown as being executed on a single electronic device, such as one of electronic devices 102a-102d, by one or more cloud servers, such as by one or more of the application server 106 and/or database server 108, or a combination of electronic devices and servers in a distributed environment. For instance, model inputs 503 provided to the portfolio optimization network 502 could be provided by an electronic device that executed the feeder model 501, such as one of the electronic devices 102a-102d, with the inputs 503 being transmitted over a network to one or more remote servers, such as the application server 106 and/or the database server 108, with the one or more remote servers executing the portfolio optimization network 502 to provide outputs 516 that are then transmitted back to the electronic device that provided the inputs 503.

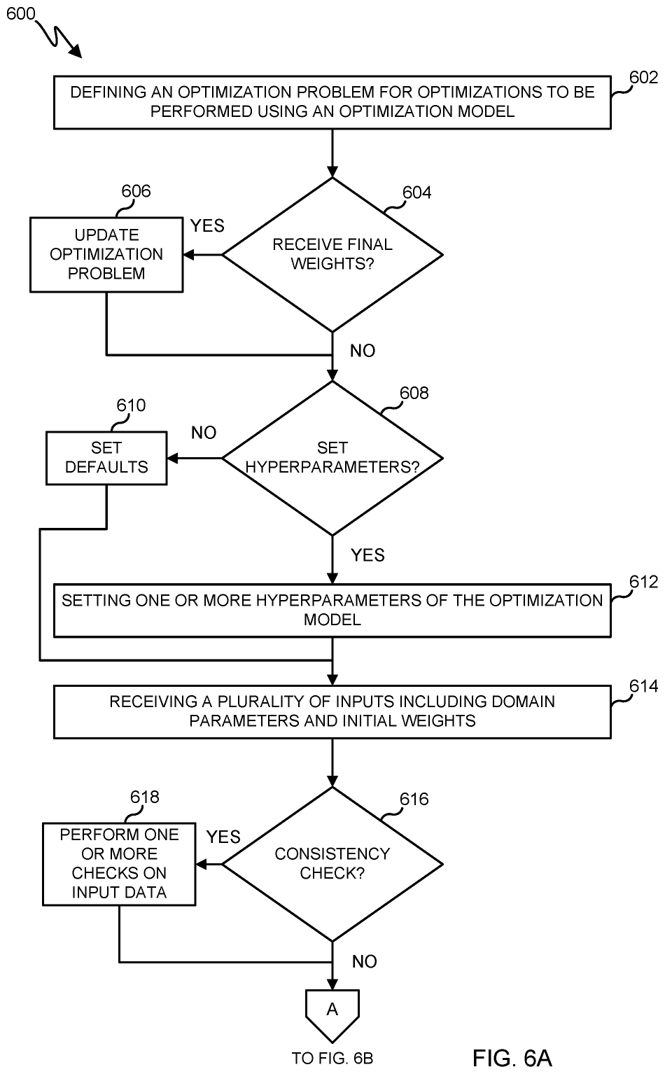

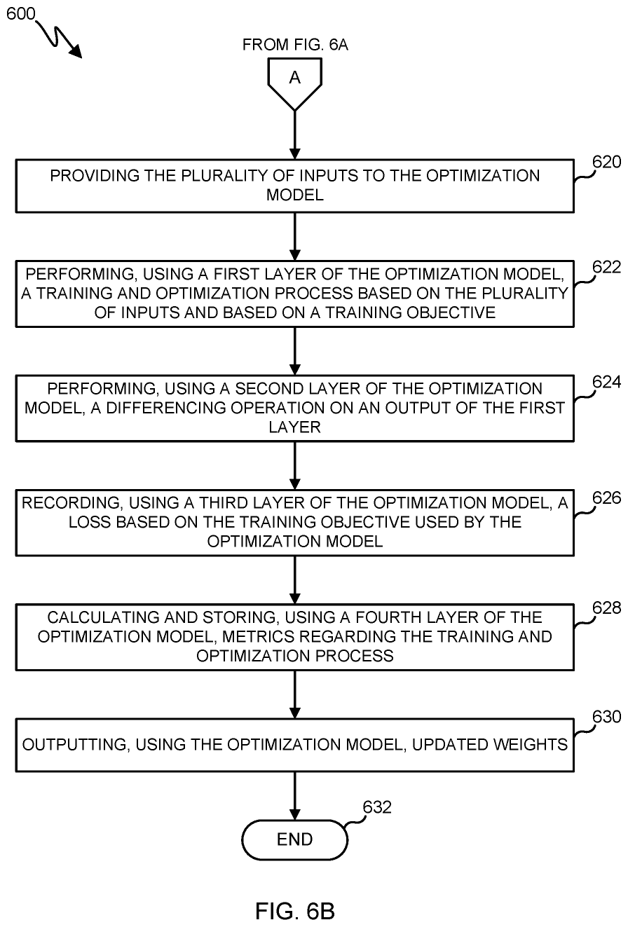

FIGS. 6A and 6B illustrate an example method 600 for performing a training and optimization process using an optimization model in accordance with this disclosure. For ease of explanation, the method 600 shown in FIGS. 6A and 6B is described as being performed using a processor of an electronic device, such as using one or more applications 112 executed by the application server 106 of FIG. 1, and/or the database server 108, where the application server 106 and the database server 108 may be implemented using one or more devices 200 of FIG. 2. However, the method 600 may be performed using any other suitable device(s), such as an electronic device like electronic devices 102a-102d, and in any other suitable system(s).

At block 602, a processor of the electronic device defines an optimization problem for optimizations to be performed using an optimization model such as the optimization model 302, the optimization network 402, and/or the optimization network 502 of this disclosure. For example, the optimization problem can be various optimization problems such as a multi-period optimization problem, an alpha harvesting problem, a rebalancing problem (such as a portfolio rebalancing problem), a replication problem (such as a portfolio replication problem), etc.

At decision block 604, the processor determines whether final weight parameters are received or are to be received as inputs to the optimization model. In various embodiments of this disclosure, the final weight parameters can be provided depending on the type of optimization problem to be solved by the optimization model. For example, when no final weight parameters are provided, the optimization problem, such as a multi-period portfolio optimization, can become an alpha-harvesting problem that seeks excess return for a given forecasting. If the final weight parameters (e.g., target portfolio weights) are provided, the optimization problem can become a rebalancing problem where the end results (the final weight parameters) are given, but the path to get there is found by the optimization model, implemented across multiple periods to reduce the transaction cost.

If, at decision block 604, the processor determines that final weight parameters are received or are to be received as inputs to the optimization model, the method 600 moves to block 606. At block 606, the processor updates the optimization problem to be solved, and/or constraints used, by the optimization model and the process moves to decision block 608. If, at decision block 604, the processor determines that final weight parameters are not received or are not to be received as inputs to the optimization model, the method 600 moves to decision block 608. At decision block 608, the processor determines whether to set hyperparameters for the optimization model.

For example, such hyperparameters can include at least one of whether the first layer of the optimization model is a dense layer or a recurrent layer, a number of hidden layers of the first layer of the optimization model, a number of units per hidden layer of the first layer of the optimization model, and a maximum number of epochs for the training objective. These hyperparameters can also include setting kernel initializers, bias initializers, whether to use bias, intermediary activation functions, an initial learning rate(s) for the optimization model, exponential decay rate for first moment estimates performed by the optimization model, exponential decay rate for second moment estimates performed by the optimization model a numerical stability constant (e.g., a very small number to prevent any division by zero in the implementation), and/or minimum delta value for the early stopping convergence criterion.

If, at decision block 608, the processor determines that hyperparameters are not to be set, the method 600 moves to block 610 at which the processor sets default hyperparameters. For example, some default hyperparameters can include setting the optimization model to use dense layers, with, as just one example, 4 hidden layers and 16 units per layer. In various embodiments, these defaults can be changed, such as if it is determined over time that the optimization problems most often being applied using the optimization model utilize certain parameters that are then set to be the default parameters for the optimization model. In some embodiments, default parameters may be stored for different optimization problems, different feeder models, etc. The method 600 moves from block 610 to block 614. If, at decision block 608, the processor determines that hyperparameters are to be set, the method 600 moves to block 612 at which the processor sets the chosen hyperparameters received, for example, based on a user input, transmission, or other interaction with the electronic device. The method 600 then moves to block 614.

At block 614, the processor receives a plurality of inputs including domain parameters and initial weights. For example, when the optimization model is performing a training and optimization process that includes performing a multi-period portfolio optimization, the plurality of inputs can include returns data, risks data, volumes data, and initial weights from a feeder model. At decision block 616, the processor determines whether to perform one or more data consistency checks on the input data received at block 614. If, at decision block 616, the processor determines that one or more consistency checks are to be performed on the input data, the method 600 moves to block 618. At block 618, the processor performs one or more data consistency checks on the input data. For example, in some embodiments, the processor can at least one data consistency check that includes one or more of checking that projected returns and volumes are in a certain range, checking that a variance-covariance matrix associated with the risks data is positive semidefinite, checking that the variance-covariance matrix associated with the risks data is positive definite, checking a consistency of a number of securities, checking validity of the volumes data, checking a feasibility of one or more constraints, and/or performing a boundless check on the plurality of inputs. The method 600 then moves to block 620.

If, at decision block 616, the processor determines that one or more consistency checks are not to be performed on the input data, the method 600 moves to block 620. At block 620, the processor provides the plurality of inputs to the optimization model. At block 622, the processor performs, using a first layer of the optimization model, a training and optimization process based on the plurality of inputs and based on a training objective. In some embodiments, this includes performing model fitting based on the plurality of inputs to fit a neural network with backpropagation. For example, in some embodiments, performing the model fitting includes adapting parameter learning rates in real time based on an average of first and second moments by calculating an exponential moving average of a gradient and a moving average of a squared gradient, controlling decay rates of the exponential moving average of the gradient and the moving average of the squared gradient, bias correcting one or more weight parameters, and updating the initial weights using the bias corrected one or more weight parameters. As just one example of this disclosure, performing the training and optimization process can include performing a multi-period portfolio optimization, wherein the plurality of inputs includes returns data, risks data, volumes data, and initial weights from one or more feeder models, and wherein the goal of the optimization model is to output multi-period weights for a defined time period that maximize returns for a given forecasting based on market impact predictions.

At block 624, the processor performs, using a second layer of the optimization model, a differencing operation on an output of the first layer. At block 626, the processor records, using a third layer of the optimization model, a loss based on the training objective used by the optimization model. At block 628, the processor calculates and stores, using a fourth layer of the optimization model, metrics regarding the training and optimization process. At block 630, the processor outputs, using the optimization model, updated weights. For example, the optimization model can output multi-period weights for a defined time period, or other outputs depending on the optimization problem.

As described in this disclosure, such as with respect to FIG. 3 and with respect to Equations (1)-(4), the optimization model uses an optimization/fitting process to optimize the inputs provided to the portfolio optimization model to provide for updated and enhanced parameters, such as the multi-period weights, to be used for more accurate predictions such as portfolio predictions. As described in this disclosure, the optimization process can include constructing a neural network loss function using user-specified market inputs (returns, risks, volumes) that define the objective function and optionally combining this with any specified soft constraints. The model then uses a batch of 1 x₀ to propagate and backpropagate through the network a number of times (epochs), corresponding to one iteration of the portfolio optimization model. In some embodiments, a maximum number of epochs and an early stopping criterion based on the loss function default to reasonable values, but can be adjusted as one of the hyperparameters at blocks 608, 612, such as at to trade off optimization time and precision. When the loss function stops decreasing significantly with every epoch, the model has converged and has found the trainable parameters of the neural network which allows mapping from x₀ into the optimal weights W*.

Although the portfolio optimization model uses neural networks, the optimization model is unique in that the training/learning objective of the optimization model is not necessarily to achieve a resulting neural network that performs well out of sample. Rather, it is the fitting process that is the focus of the optimization model, as this gives the weights which optimize the objective/constraints. Also, the fitting process is performed not only for any changes to the objective functions and constraints (such as adding a constraint, changing the risk sensitivity), but also to the underlying data (such as market data including returns, risk, etc.), as together these define the loss function of the neural network and, therefore, change the problem, and thus define any change to the optimization problem. The method 600 ends at block 632.

Although FIGS. 6A and 6B illustrate one example of a method 600 for performing a training and optimization process using an optimization model, various changes may be made to FIGS. 6A and 6B. For example, while shown as a series of steps, various steps in FIGS. 6A and 6B could overlap, occur in parallel, occur in a different order, or occur any number of times. For instance, decision block 604 could occur before block 602, such that it is determined whether final weight parameters are to be used prior to step of defining the optimization problem at block 602. Similarly, in some embodiments, receiving the plurality of inputs at block 614 could occur prior to block 602, such that the received inputs are considered when defining the optimization problem to be solved using the optimization model. Additionally, defining the optimization problem at block 602 can also involve setting one or more constraints as described in the various embodiments of this disclosure.

In one example embodiment, a method comprises receiving a plurality of inputs including domain parameters and initial weights, providing the plurality of inputs to an optimization model, performing, using a first layer of the optimization model, a training and optimization process based on the plurality of inputs and based on a training objective, performing, using a second layer of the optimization model, a differencing operation on an output of the first layer, recording, using a third layer of the optimization model, a loss based on the training objective used by the optimization model, calculating and storing, using a fourth layer of the optimization model, metrics regarding the training and optimization process, and, outputting, using the optimization model, updated weights.

In one or more of the above examples, the method further comprises setting one or more hyperparameters of the optimization model, wherein the one or more hyperparameters include at least one of whether the first layer of the optimization model is a dense layer or a recurrent layer, a number of hidden layers of the first layer of the optimization model, a number of units per hidden layer of the first layer of the optimization model, and a maximum number of epochs for the training objective.

In one or more of the above examples, performing, using the first layer of the optimization model, the training and optimization process includes performing model fitting based on the plurality of inputs to fit a neural network with backpropagation.

In one or more of the above examples, performing the model fitting includes adapting parameter learning rates in real time based on an average of first and second moments by calculating an exponential moving average of a gradient and a moving average of a squared gradient, controlling decay rates of the exponential moving average of the gradient and the moving average of the squared gradient, bias correcting one or more weight parameters, and updating the initial weights using the bias corrected one or more weight parameters.

In one or more of the above examples, the plurality of inputs further includes final weight parameters, and performing the training and optimization process includes performing a rebalancing process in which a path to achieve the final weight parameters is determined by the optimization model.

In one or more of the above examples, performing the training and optimization process includes performing a multi-period portfolio optimization, wherein the plurality of inputs includes returns data, risks data, volumes data, and the initial weights from a feeder model, and wherein the optimization model outputs multi-period weights for a defined time period.

In one or more of the above examples, the multi-period portfolio optimization maximizes returns for a given forecasting based on market impact predictions.

In one or more of the above examples, the method further comprises performing at least one data consistency check on at least one input of the plurality of inputs, wherein the at least one data consistency check includes one or more of checking that projected returns and volumes are in a certain range, checking that a variance-covariance matrix associated with the risks data is positive semidefinite, checking that the variance-covariance matrix associated with the risks data is positive definite, checking a consistency of a number of securities, checking validity of the volumes data, checking a feasibility of one or more constraints, and performing a boundless check on the plurality of inputs.

In another example embodiment, an apparatus comprises at least one processor supporting optimization, wherein the at least one processor is configured to receive a plurality of inputs including domain parameters and initial weights, provide the plurality of inputs to an optimization model, perform, using a first layer of the optimization model, a training and optimization process based on the plurality of inputs and based on a training objective, perform, using a second layer of the optimization model, a differencing operation on an output of the first layer, record, using a third layer of the optimization model, a loss based on the training objective used by the optimization model, calculate and store, using a fourth layer of the optimization model, metrics regarding the training and optimization process, and output, using the optimization model, updated weights.

In one or more of the above examples, the at least one processor is further configured to set one or more hyperparameters of the optimization model, wherein the one or more hyperparameters include at least one of whether the first layer of the optimization model is a dense layer or a recurrent layer, a number of hidden layers of the first layer of the optimization model, a number of units per hidden layer of the first layer of the optimization model, and a maximum number of epochs for the training objective.

In one or more of the above examples, to perform, using the first layer of the optimization model, the training and optimization process, the at least one processor is further configured to perform model fitting based on the plurality of inputs to fit a neural network with backpropagation.

In one or more of the above examples, to perform the model fitting, the at least one processor is further configured to adapt parameter learning rates in real time based on an average of first and second moments by calculating an exponential moving average of a gradient and a moving average of a squared gradient, control decay rates of the exponential moving average of the gradient and the moving average of the squared gradient, bias correct one or more weight parameters, and update the initial weights using the bias corrected one or more weight parameters.

In one or more of the above examples, the plurality of inputs further includes final weight parameters, and wherein, to perform the training and optimization process, the at least one processor is further configured to perform a rebalancing process in which a path to achieve the final weight parameters is determined by the optimization model.

In one or more of the above examples, to perform the training and optimization process, the at least one processor is further configured to perform a multi-period portfolio optimization, wherein the plurality of inputs includes returns data, risks data, volumes data, and the initial weights from a feeder model, and the optimization model outputs multi-period weights for a defined time period.

In one or more of the above examples, the multi-period portfolio optimization maximizes returns for a given forecasting based on market impact predictions.

In one or more of the above examples, the at least one processor is further configured to perform at least one data consistency check on at least one input of the plurality of inputs, wherein the at least one data consistency check includes one or more of a check that projected returns and volumes are in a certain range, a check that a variance-covariance matrix associated with the risks data is positive semidefinite, a check that the variance-covariance matrix associated with the risks data is positive definite, a check of a consistency of a number of securities, a check of validity of the volumes data, a check of a feasibility of one or more constraints, and a boundless check on the plurality of inputs.

In another example embodiment, a non-transitory computer readable medium contains instructions that support optimization and that when executed cause at least one processor to receive a plurality of inputs including domain parameters and initial weights, provide the plurality of inputs to an optimization model, perform, using a first layer of the optimization model, a training and optimization process based on the plurality of inputs and based on a training objective, perform, using a second layer of the optimization model, a differencing operation on an output of the first layer, record, using a third layer of the optimization model, a loss based on the training objective used by the optimization model, calculate and store, using a fourth layer of the optimization model, metrics regarding the training and optimization process, and output, using the optimization model, updated weights.

In one or more of the above examples, the non-transitory computer readable medium further containing instructions that when executed cause the at least one processor to set one or more hyperparameters of the optimization model, wherein the one or more hyperparameters include at least one of whether the first layer of the optimization model is a dense layer or a recurrent layer, a number of hidden layers of the first layer of the optimization model, a number of units per hidden layer of the first layer of the optimization model, and a maximum number of epochs for the training objective.

In one or more of the above examples, to perform, using the first layer of the optimization model, the training and optimization process, the non-transitory computer readable medium further contains instructions that when executed cause the at least one processor to perform model fitting based on the plurality of inputs to fit a neural network with backpropagation, wherein, to perform the model fitting, the instructions when executed further cause the at least one processor to adapt parameter learning rates in real time based on an average of first and second moments by calculating an exponential moving average of a gradient and a moving average of a squared gradient, control decay rates of the exponential moving average of the gradient and the moving average of the squared gradient, bias correct one or more weight parameters, and update the initial weights using the bias corrected one or more weight parameters.

In one or more of the above examples, to perform the training and optimization process, the non-transitory computer readable medium further contains instructions that when executed cause the at least one processor to perform a multi-period portfolio optimization, wherein the plurality of inputs includes returns data, risks data, volumes data, and the initial weights from a feeder model, wherein the optimization model outputs multi-period weights for a defined time period, and wherein the multi-period portfolio optimization maximizes returns for a given forecasting based on market impact predictions.

Although this disclosure has been described with example embodiments, various changes and modifications may be suggested to one skilled in the art. It is intended that this disclosure encompass such changes and modifications as fall within the scope of the appended claims.

What is claimed is:

1. A method comprising:
receiving a plurality of inputs including domain parameters and initial weights;
providing the plurality of inputs to an optimization model;
performing, using a first layer of the optimization model, a training and optimization process based on the plurality of inputs and based on a training objective;
performing, using a second layer of the optimization model, a differencing operation on an output of the first layer;
recording, using a third layer of the optimization model, a loss based on the training objective used by the optimization model;
calculating and storing, using a fourth layer of the optimization model, metrics regarding the training and optimization process; and
outputting, using the optimization model, updated weights.

2. The method of claim 1, further comprising:
setting one or more hyperparameters of the optimization model, wherein the one or more hyperparameters include at least one of:
whether the first layer of the optimization model is a dense layer or a recurrent layer;
a number of hidden layers of the first layer of the optimization model;
a number of units per hidden layer of the first layer of the optimization model; and
a maximum number of epochs for the training objective.

3. The method of claim 1, wherein performing, using the first layer of the optimization model, the training and optimization process includes performing model fitting based on the plurality of inputs to fit a neural network with backpropagation.

4. The method of claim 3, wherein performing the model fitting includes:
adapting parameter learning rates in real time based on an average of first and second moments by calculating an exponential moving average of a gradient and a moving average of a squared gradient;
controlling decay rates of the exponential moving average of the gradient and the moving average of the squared gradient;
bias correcting one or more weight parameters; and
updating the initial weights using the bias corrected one or more weight parameters.

5. The method of claim 1, wherein the plurality of inputs further includes final weight parameters, and wherein performing the training and optimization process includes performing a rebalancing process in which a path to achieve the final weight parameters is determined by the optimization model.

6. The method of claim 1, wherein performing the training and optimization process includes performing a multi-period portfolio optimization, wherein the plurality of inputs includes returns data, risks data, volumes data, and the initial weights from a feeder model, and wherein the optimization model outputs multi-period weights for a defined time period.

7. The method of claim 6, wherein the multi-period portfolio optimization maximizes returns for a given forecasting based on market impact predictions.

8. The method of claim 6, further comprising performing at least one data consistency check on at least one input of the plurality of inputs, wherein the at least one data consistency check includes one or more of:
checking that projected returns and volumes are in a certain range;
checking that a variance-covariance matrix associated with the risks data is positive semidefinite;
checking that the variance-covariance matrix associated with the risks data is positive definite;
checking a consistency of a number of securities;
checking validity of the volumes data;
checking a feasibility of one or more constraints; and
performing a boundless check on the plurality of inputs.

9. An apparatus comprising:
at least one processor supporting optimization, wherein the at least one processor is configured to:
receive a plurality of inputs including domain parameters and initial weights;
provide the plurality of inputs to an optimization model;
perform, using a first layer of the optimization model, a training and optimization process based on the plurality of inputs and based on a training objective;
perform, using a second layer of the optimization model, a differencing operation on an output of the first layer;
record, using a third layer of the optimization model, a loss based on the training objective used by the optimization model;
calculate and store, using a fourth layer of the optimization model, metrics regarding the training and optimization process; and
output, using the optimization model, updated weights.

10. The apparatus of claim 9, wherein the at least one processor is further configured to:
set one or more hyperparameters of the optimization model, wherein the one or more hyperparameters include at least one of:
whether the first layer of the optimization model is a dense layer or a recurrent layer;
a number of hidden layers of the first layer of the optimization model;
a number of units per hidden layer of the first layer of the optimization model; and
a maximum number of epochs for the training objective.

11. The apparatus of claim 9, wherein, to perform, using the first layer of the optimization model, the training and optimization process, the at least one processor is further configured to perform model fitting based on the plurality of inputs to fit a neural network with backpropagation.

12. The apparatus of claim 11, wherein, to perform the model fitting, the at least one processor is further configured to:
adapt parameter learning rates in real time based on an average of first and second moments by calculating an exponential moving average of a gradient and a moving average of a squared gradient;
control decay rates of the exponential moving average of the gradient and the moving average of the squared gradient;
bias correct one or more weight parameters; and
update the initial weights using the bias corrected one or more weight parameters.

13. The apparatus of claim 9, wherein the plurality of inputs further includes final weight parameters, and wherein, to perform the training and optimization process, the at least one processor is further configured to perform a rebalancing process in which a path to achieve the final weight parameters is determined by the optimization model.

14. The apparatus of claim 9, wherein, to perform the training and optimization process, the at least one processor is further configured to perform a multi-period portfolio optimization, wherein the plurality of inputs includes returns data, risks data, volumes data, and the initial weights from a feeder model, and wherein the optimization model outputs multi-period weights for a defined time period.

15. The apparatus of claim 14, wherein the multi-period portfolio optimization maximizes returns for a given forecasting based on market impact predictions.

16. The apparatus of claim 14, wherein the at least one processor is further configured to perform at least one data consistency check on at least one input of the plurality of inputs, wherein the at least one data consistency check includes one or more of:
a check that projected returns and volumes are in a certain range;
a check that a variance-covariance matrix associated with the risks data is positive semidefinite;
a check that the variance-covariance matrix associated with the risks data is positive definite;
a check of a consistency of a number of securities;
a check of validity of the volumes data;
a check of a feasibility of one or more constraints; and
a boundless check on the plurality of inputs.

17. A non-transitory computer readable medium containing instructions that support optimization and that when executed cause at least one processor to:
receive a plurality of inputs including domain parameters and initial weights;
provide the plurality of inputs to an optimization model;
perform, using a first layer of the optimization model, a training and optimization process based on the plurality of inputs and based on a training objective;
perform, using a second layer of the optimization model, a differencing operation on an output of the first layer;
record, using a third layer of the optimization model, a loss based on the training objective used by the optimization model;
calculate and store, using a fourth layer of the optimization model, metrics regarding the training and optimization process; and
output, using the optimization model, updated weights.

18. The non-transitory computer readable medium of claim 17, further containing instructions that when executed cause the at least one processor to:
set one or more hyperparameters of the optimization model, wherein the one or more hyperparameters include at least one of:
whether the first layer of the optimization model is a dense layer or a recurrent layer;
a number of hidden layers of the first layer of the optimization model;
a number of units per hidden layer of the first layer of the optimization model; and
a maximum number of epochs for the training objective.

19. The non-transitory computer readable medium of claim 17, wherein, to perform, using the first layer of the optimization model, the training and optimization process, the non-transitory computer readable medium further contains instructions that when executed cause the at least one processor to perform model fitting based on the plurality of inputs to fit a neural network with backpropagation, wherein, to perform the model fitting, the instructions when executed further cause the at least one processor to:
adapt parameter learning rates in real time based on an average of first and second moments by calculating an exponential moving average of a gradient and a moving average of a squared gradient;
control decay rates of the exponential moving average of the gradient and the moving average of the squared gradient;
bias correct one or more weight parameters; and
update the initial weights using the bias corrected one or more weight parameters.

20. The non-transitory computer readable medium of claim 17, wherein, to perform the training and optimization process, the non-transitory computer readable medium further contains instructions that when executed cause the at least one processor to perform a multi-period portfolio optimization, wherein the plurality of inputs includes returns data, risks data, volumes data, and the initial weights from a feeder model, and wherein the optimization model outputs multi-period weights for a defined time period, and wherein the multi-period portfolio optimization maximizes returns for a given forecasting based on market impact predictions.
